(19) United States
(12) Patent Application Publication
(10) Pub. No.: US 2013/0275957 A1
(43) Pub. Date: Oct. 17, 2013

(54) CUSTOMIZING APPLIANCES

(71) Applicants: Nicolas Villar, Cambridge (GB); James Scott, Cambridge (GB); Stephen Hodges, Cambridge (GB); Christian Winkler, Bochum (DE)

(72) Inventors: Nicolas Villar, Cambridge (GB); James Scott, Cambridge (GB); Stephen Hodges, Cambridge (GB); Christian Winkler, Bochum (DE)

(73) Assignee: MICROSOFT CORPORATION, Redmond, WA (US)

(21) Appl. No.: 13/445,520

(22) Filed: Apr. 12, 2012

(51) Int. Cl. G06F 9/44

(52) U.S. Cl. 717/173; 717/172

(57) ABSTRACT

Configuring appliances is described. In an embodiment an appliance, for example, a domestic appliance can have both a physical user interface, for example the buttons on the appliance and a remote user interface. In various embodiments a user can access the remote user interface by connecting to a network interface associated with the appliance using a client device. The client device can display the remote user interface of the appliance and the user can use the remote user interface to configure settings and functions of the appliance and of the physical and remote user interfaces. In various embodiments the remote user interface can be used in combination with the physical user interface. In various embodiments the remote user interface is a development environment which enables the user to change the functionality of the appliance by altering or replacing program files which are executed at the appliance.

### BACKGROUND

Home, office and industrial appliances have increasingly complex functionality, which can often only be exposed to users in a very specific way. How the user is exposed to the functionality of the appliance may be restricted by the physical form of the user interface of the appliance, which for aesthetic or other reasons may be very limited. For example a coffee machine may have many settings relating to the temperature and pressure of the water, the strength of the coffee and other settings. These settings may only be accessed by the user by pressing a complex combination of buttons on the physical user interface. The correct combination can be difficult to remember and to execute successfully.

Appliances which are connected to displays and therefore may have complex menus displayed on a graphical user interface, for example a set-top box or DVD player which is connected to a television, may still only expose a limited amount of functionality to the user, for example, the user may be able to change the brightness, resolution and other settings, but only within a range which is specified by the manufacturer.

The embodiments described below are not limited to implementations which solve any or all of the disadvantages of known customizable appliances.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

Customizing appliances is described. In an embodiment an appliance can have both a physical user interface, for example the buttons on the appliance, and a remote user interface. In various embodiments a user can access the remote user interface using a client device by connecting to a network interface associated with the appliance. The client device may display the remote user interface of the appliance and the user can use the remote user interface to configure settings or functions of the appliance or of the physical or remote user interfaces. In various embodiments the remote user interface may be used in combination with the physical user interface. In various embodiments the remote user interface may provide a development environment which enables the user to change the functionality of the appliance by altering or replacing program files which are executed at the appliance.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of an example system for configuring appliances;

FIG. 2 shows two flow diagrams of example methods of configuring appliances, the first example method is implemented on a client device and the second example method is implemented on an appliance;

FIG. 3 is a schematic diagram of various example hardware layers that can be implemented on a configurable appliance;

FIG. 4 is a schematic diagram of a plurality of example layers on an appliance which may be exposed to a user of a client device via a network;

FIG. 5 is a schematic diagram of an example remote user interface displayed on a client device;

FIG. 6 is a flow diagram of an example method of carrying out reflection and interpretation on program files;

FIG. 7 is a schematic diagram of an example system for sharing and executing program files over multiple appliances;

FIG. 8 is a flow diagram of an example method of sharing program files between multiple appliances;

FIG. 9 illustrates an exemplary device in which embodiments of methods for configuring appliances described herein may be implemented; and

FIG. 10 illustrates another exemplary device in which embodiments of methods for configuring appliances described herein may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in one type of computing system, the system described is provided as an example and not a limitation. As those skilled in the art will appreciate, the present examples are suitable for application in a variety of different types of computing systems.

The term “appliance” is used herein to refer to an electrical device which is operated for a particular purpose or to perform a specific task. The term encompasses home (or consumer) appliances, office appliances, industrial appliances and appliances for other purposes. A home appliance, for example, may be an appliance designed for a specific domestic task, such as laundry, cooking or vacuuming. An industrial appliance may be an appliance designed to perform a particular industrial function, and may, for example, be designed to operate as part of an assembly line. An industrial appliance may, for example, be an industrial robot designed for welding, painting, assembly, picking and placement of goods, product inspection, or testing.

Appliances typically have a limited amount of computing functionality, for example the ability to execute pre-installed instructions installed as firmware; however, as described above the user has very little exposure to these functions. There is no opportunity for the user to customize the device any further than changing any settings within a manufacturer defined range. In order to customize the appliance further it may be necessary to replace or upgrade the software on the appliance with new software written by the manufacturer, or with customized software written by the user or a third party. However, replacing the software can be difficult and time consuming and many users may be unable to successfully carry out this procedure due to the complexity and the level of specialist knowledge of the device required.

As described above, appliances often have an increasingly complex range of functions and settings, but they often also have a limited physical interface through which a user can make changes to settings. The limited physical interface reduces the cost of the device and is often considered an aesthetic design feature, but increases the complexity of interacting with the device from a user perspective. Furthermore, there may be functions or settings that the appliance can internally support, but which are not available to the user due to the limited physical interface being unable to support them.

In an example, a coffee maker is an appliance. A user of the coffee machine may wish to alter the coffee that the machine makes, e.g. the user may wish to change the temperature of the water used or the water hardness settings of the machine which allow it to compensate for water hardness. To change these settings using the physical buttons on the machine may involve accessing the user manual (either a printed user manual or an electronic user manual) in order to find the correct combination of buttons to press, followed by a laborious sequence of button presses. Many, but not all, appliances have a small display and where there is a display, the user may be able to obtain some limited feedback on the display to indicate that their operation is successful or as a prompt to the button presses required. However, the appliance may have no display, and may either have more limited forms of feedback such as LEDs or no feedback mechanism at all, in which case the user will have to perform the sequence correctly without clear feedback and may end up using trial and error to change the settings. Furthermore, some settings, e.g. the pressure of the water used, may not be accessible at all through the limited user interface, despite the machine internally having control over this factor.

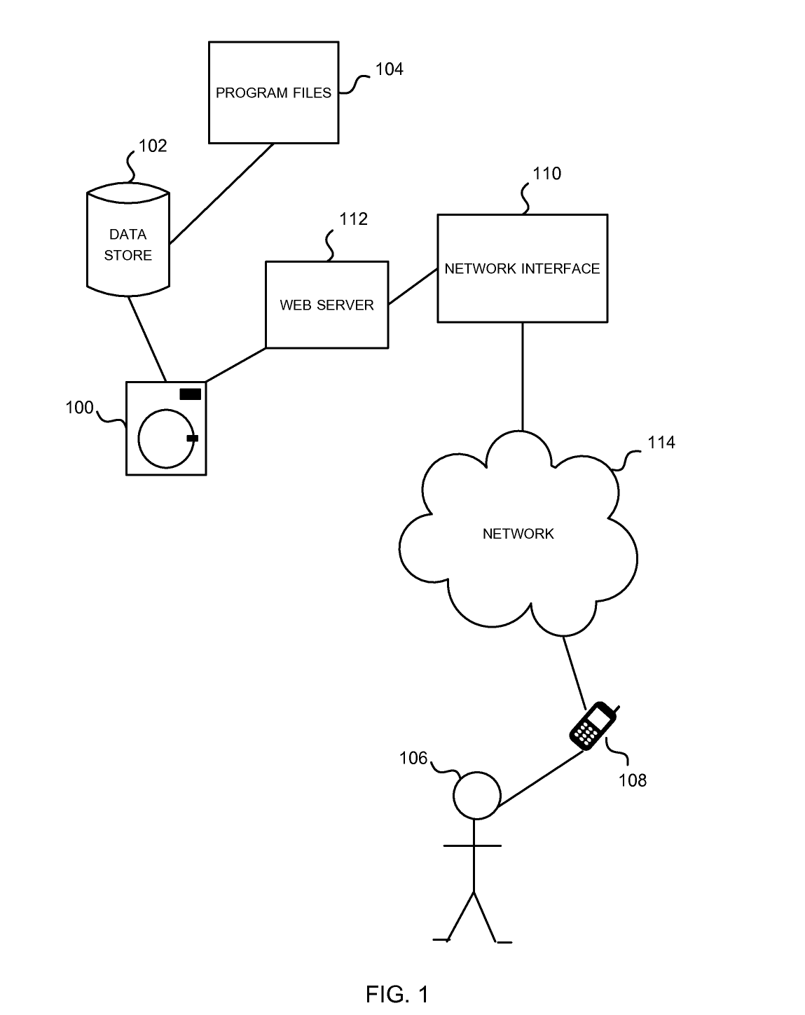

FIG. 1 is a schematic diagram of an example system for configuring appliances. An appliance 100, for example, a home appliance or industrial appliance, has a data store 102 arranged to store program files 104 which control various functions of the appliance. In an example the program files may control functions of the physical hardware of the appliance, e.g. button functions, motor speeds or other physical functions. The physical functions may be functions related to the operation of the appliance or functions related to the operation of a physical user interface (e.g. the mapping of buttons to functions). The program files may also be arranged to execute software functions that run on the device, e.g. a timer, a news feed, synchronizing with other devices or other software functions. The program files may also control combinations of both software and hardware functions.

A user 106 can connect to the appliance 100 using a client device 108 via a network interface 110. The network interface 110 may be integrated with or in communication with the appliance. The appliance 100 may comprise a web-server 112 which is arranged to deliver content to the client device 108 via a network 114. The content delivered to the client device 108 may be a remote user interface (RUI) of the appliance 100. The remote user interface may be a graphical user interface (GUI) or other interface type which can be displayed appropriately on the client device 108. The network 114 may be a wired network or a wireless network of any appropriate type or a combination of wired and wireless technologies. The user 106 of the client device may, for example, be an owner of the appliance 100 or an appliance engineer. The client device 108 may be a mobile phone, a laptop or tablet computer, or other computing device. In various examples an existing appliance may be retrofitted with a network interface 110 in order to provide the functionality of a remote user interface to a client device.

The web-server 112 may be arranged to generate the remote user interface, which may be specific to the appliance 100. The web-server may also be arranged to serve the remote user interface to the client device 108. The client device may then display the remote user interface in a browser window without the need for any proprietary software from the manufacturer of the appliance or the manufacturer of the client device. In an example the client device 108 may act as a thin client for the web-server 112 of the appliance.

The remote user interface allows a user to access and alter the program files 104. Altering the program files may comprise editing or replacing one or more of the program files. These program files 104 may be edited remotely via the RUI (e.g. they may be edited in-situ on the appliance) or they may be downloaded to the client device 108, edited on that device and then returned (in edited form) to the appliance 100 (where the edited program files will be stored and executed).

By allowing a user to edit program files which are run on the appliance, the remote user interface allows the user to control, configure or alter one or more aspects of the functionality of the appliance. In addition, the RUI may be arranged to allow a user to change settings of the device, for example, the user may use a touch-screen of the client device displaying the RUI to move a slider, check or uncheck a box or perform another action which changes a setting of the appliance. In an example executing the edited program files may add or remove menu options or change the configuration of the user interface.

In various examples, the remote user interface is in the form of one or more webpages (e.g. as provided by web-server 112) which may allow a user to edit programs via a web browser using a simplified markup language, a rich-text editor or other appropriate means of editing. In an example the remote user interface may be an editable webpage. An example format for an editable webpage is a wiki page.

In various examples, the remote user interface may provide the user with a development environment (for example an integrated development environment) which allows the user to access or edit program files 104 stored at the appliance. This development environment may be run on the appliance and the GUI of the development environment may be exposed to the user as the RUI on the client device 108. Alternatively, the development environment may be downloaded from the appliance 100 to the client device 108 and executed on the client device. The integrated development environment may be a single program in which all alteration of program files is carried out and may provide a plurality of features for altering various aspects of the program files, for example, the development environment may allow the user to execute various tasks for authoring, modifying, compiling, deploying and debugging program files.

The development environment and/or the program files 104 may be at least partially stored on a remote device, e.g. a cloud service or web service associated with the appliance, which can assist the appliance 100 in providing the remote user interface. The cloud service may, for example, be a service run by the manufacturer of appliance. In an example the client device 108 may download JavaScript, images or other components used in implementing the remote user interface from the remote device.

As described above, by editing program files 104 the user can change the functionality of the appliance 100 (i.e. the user can change the way the appliance actually operates) and the user may also be able to alter various aspects of the local or remote user interface.

In an example, where the remote user interface provides one or more simpler interface pages (e.g. webpages for changing device settings) in addition to the RUI which enables a user to edit program files, a user may also be able to add or delete features of the simpler interface pages which control one or more aspects of the appliance such as a volume slider, a mute button, status information or other features of the user interface.

The user may also use the physical interface functions located at the appliance separately, or in combination with the remote user interface displayed at the client device to alter one or more functions of the appliance.

In an example, where the appliance is a coffee maker the user may be able to make changes to a program file which controls the function of buttons on the physical user interface. In another example the user may edit a program file relating to the settings of the thermostat of the device and the operation of the water boiler, so the water is heated to a higher or lower temperature. In another example the user may wish to make changes to the pressure at which water is passed through coffee in the machine and in such an example, the user could access and alter a program file which controls a pump for pressurizing water within the appliance. By executing this altered program file at the appliance the user makes changes to the water pressure even if the manufacturer has not specified a setting or range for this in the pre-installed menu options or even where this functionality is not exposed to the user in any way via the standard UI.

In another example where the appliance is an alarm clock, the user may be able to change the time at which the alarm is set by accessing the alarm clock using a client device. Changing the time on the alarm clock may be considered changing a setting on the alarm clock and the user may additionally access program files which control the alarm buzzer pitch or other aspects of the alarm clock function and alter those files such that executing the altered files changes one or more aspects of the function of the alarm clock (e.g. to change the snooze time or add multiple alarm settings). In another example, by editing the alarm clock program files (i.e. the program files executed by the alarm clock) the user may be able to add functions to the remote user interface of the alarm clock to enable users to specify different alarm times or to inform the user of the outside temperature. The use of a remote user interface at a client device therefore allows the user much more control of an appliance than using a physical interface integrated into the physical form of the appliance.

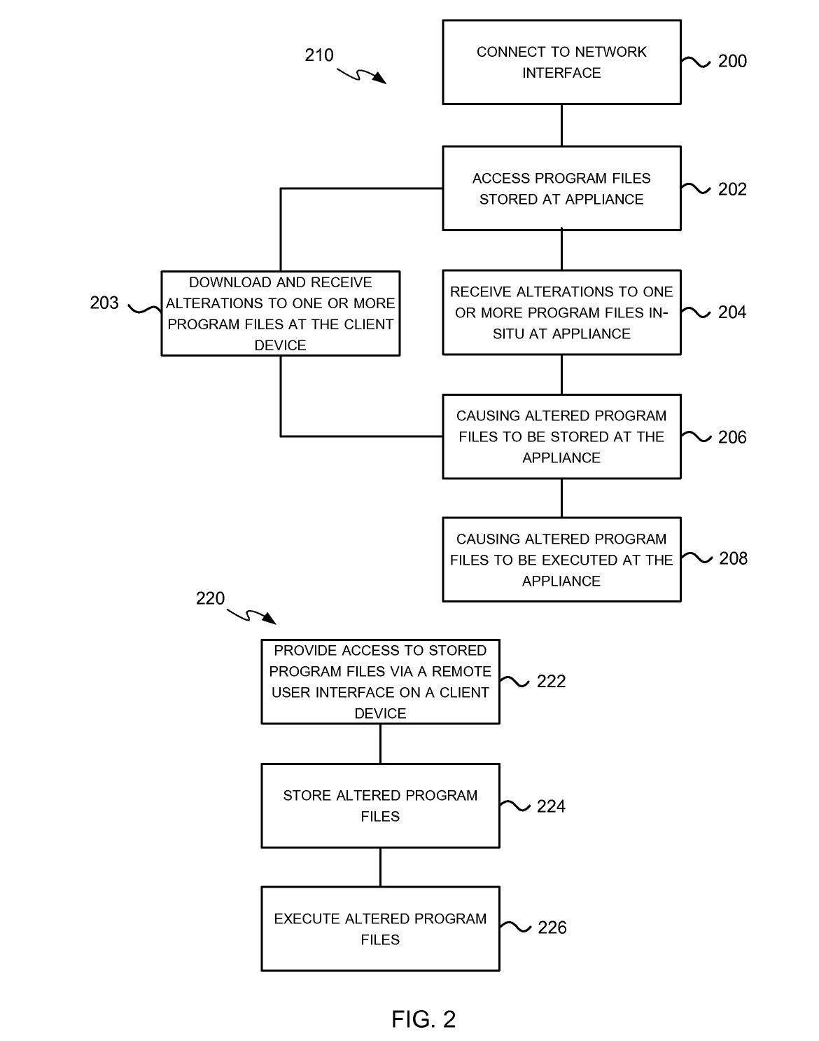

FIG. 2 shows two flow diagrams of example methods of configuring appliances; for example appliances such as those described with respect to FIG. 1. The first flow diagram 210 shows an example method implemented at a client device and the second flow diagram 220 shows an example method implemented at an appliance.

As shown in the first example method (flow diagram 210), a client device connects to a network interface which may be integrated with the appliance or in communication with the appliance (block 200). The network interface may be a wireless access point (e.g. a WiFi or Bluetooth™ access point), a network interface which allows the appliance to create an ad-hoc connection with the client device, a mobile network interface or other appropriate network interface, for example a wired connection. The client device may connect directly to the access point, or indirectly via multiple devices, for example a client device which is not in close proximity to the appliance may communicate with the appliance via the interne or a relay device (e.g. in a wireless ad-hoc network), rather than connect directly to the access point.

In an embodiment the network interface may be a Wi-Fi Direct™ interface. Conventional WiFi networks are based on the presence of controller devices known as wireless access points. These devices normally combine physical support for wireless and wired networking, bridging and routing between devices on the network, and service provisioning to add and remove devices from the network. A Wi-Fi Direct™ compliant appliance or device is able to operate as either a device or an access point. Wi-Fi Direct™ enabled appliances and devices negotiate when they first connect to determine which device acts as an access point in contrast to standard WiFi networks where the devices do not communicate directly, but they go through the access point.

The user accesses program files stored at the appliance (block 202) via a remote user interface implemented at the appliance (e.g. as described above) and alterations to the program file are received at the remote user interface. The program files are stored and executed at the appliance. In a first example, one or more program files are downloaded to the client device and altered on the client device via the user interface (block 203) and in a second example, one or more program files are altered in-situ at the appliance via the RUI (block 204).

The client device then causes the altered program files to be stored at the appliance (block 206), for example, by clicking on a ‘save’ icon within the RUI. Alternatively, the act of accessing and/or altering a program file may cause the file to be automatically stored at the appliance. The client device may also cause the altered program files to be executed at the appliance (block 208) through a similar mechanism (e.g. clicking on an ‘execute’ icon). As described above, executing the one or more of the altered program files at the appliance can change one or more aspects of the functionality of the appliance, for example executing the program file can change one or more aspects of the operation of the device, one or more functions of the physical user interface or one or more functions of the remote user interface.

As shown in the second example method (flow diagram 220) which shows the corresponding operations at the appliance, the appliance provides access via the RUI to stored program files (block 222) and as described above, the RUI allows a user to edit these files via the client device. Following editing, the appliance stores the one or more altered program files (block 224) and this storing may be performed automatically (e.g. in a similar manner to the ‘autosave’ function which exists in word processing applications) or in response to a user trigger. The one or more altered files are subsequently executed on the appliance (block 226) and again this may be initiated by the user (in block 208 of the first flow diagram) or by the appliance independently of the user.

In some embodiments initializing or turning on the appliance may comprise executing one or more program files stored in the data store at the appliance or other persistent memory. The program files may have well defined filenames or well defined locations and may be executed every time the appliance is turned on. The appliance may additionally have temporary program files which are held in non-persistent memory, for example RAM memory, and which may be run immediately when installed on the appliance. The temporary program files may affect the functioning of one or more aspects of the appliance temporarily but do not persist when the appliance is restarted. The changes in functionality instigated by the temporary program files may persist until the appliance is next rebooted and may be used to explore and test functionality before changing the programs which are stored in persistent memory and executed each time the appliance is started. If a temporary program file executes the desired actions correctly the user may have the option to store the file permanently for execution at startup.

In an example a program may be executed which states “change the function of button B from X to Y”, the effect would appear when button B was pressed, even if the program was executed some time before, however if the program is not stored persistently the function of button B will revert to X the next time the device is rebooted. In another example the water pressure of a device may be set at a first level, however, a program file may be executed at the appliance which executes a special cleaning sequence by temporarily changing the water pressure. When the device is subsequently rebooted, the water pressure may return to the previous setting.

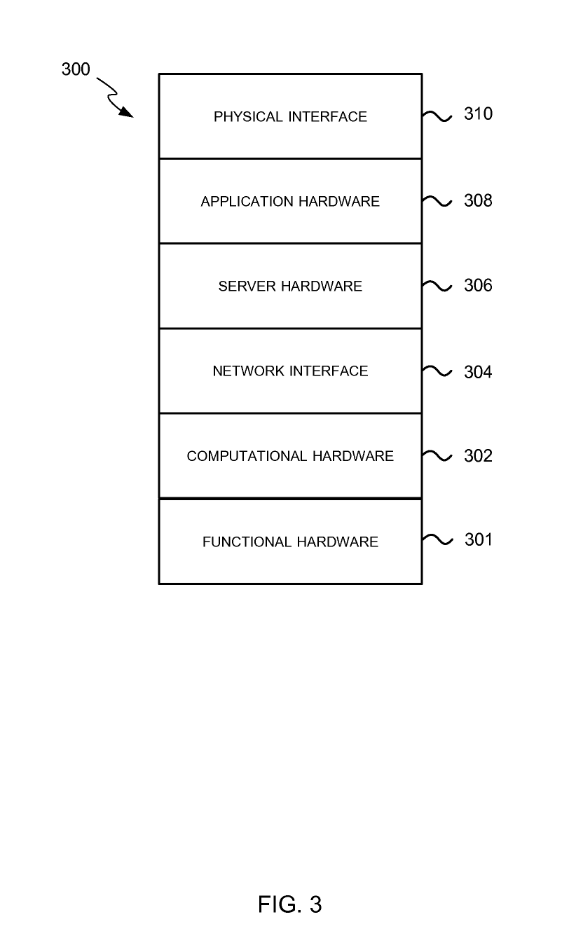

FIG. 3 is a schematic diagram of various hardware layers that may be implemented on configurable appliance. The appliance 300 may be comprised of one or more embedded computational hardware components 302 designed to execute a specific task, for example the embedded hardware components 302 may be a processor (e.g. a digital signal processor), a memory, a data store or other hardware components. For example a washer/dryer may have an embedded digital signal processor which is arranged to execute a plurality of different wash cycles, which are stored at the data store. The appliance 300 also has conventional hardware to enable the execution of the tasks for which the appliance was designed, for example; motors, compressors, filters or other mechanical hardware (functional hardware 301) and hardware to provide the functionality of a physical user interface 310, for example, buttons, LCD screens, a touch-screen and other physical interface hardware.

The appliance 300 may also comprise a network interface (which may be an integrated network interface) 304 arranged to connect the appliance to a network, for example the interne or a Local Area Network. The network interface may be integrated with or in communication with other hardware components in the appliance, for example the DSP.

The appliance 300 may comprise server hardware 306 which is integral to or in communication with the appliance. The server hardware may be arranged to serve the requests of one or more client devices connected to the appliance via the network interface 304. In various examples, the server may be partially implemented in software. In various examples the server may be a web-server arranged to serve web content to a client device and/or a domain name (DNS) server arranged to translate a domain name to an IP address.

The appliance 300 may have further application hardware 308 arranged to support applications executed on the appliance, for example a data store, CPU or GPU. In an example the application hardware 308 may be shared, integrated or in communication with the computational hardware components 302.

It will be appreciated that the layers shown in FIG. 3 are examples of possible layers and some appliances may not comprise all the layers shown in FIG. 3 and/or they may have additional layers not shown in FIG. 3.

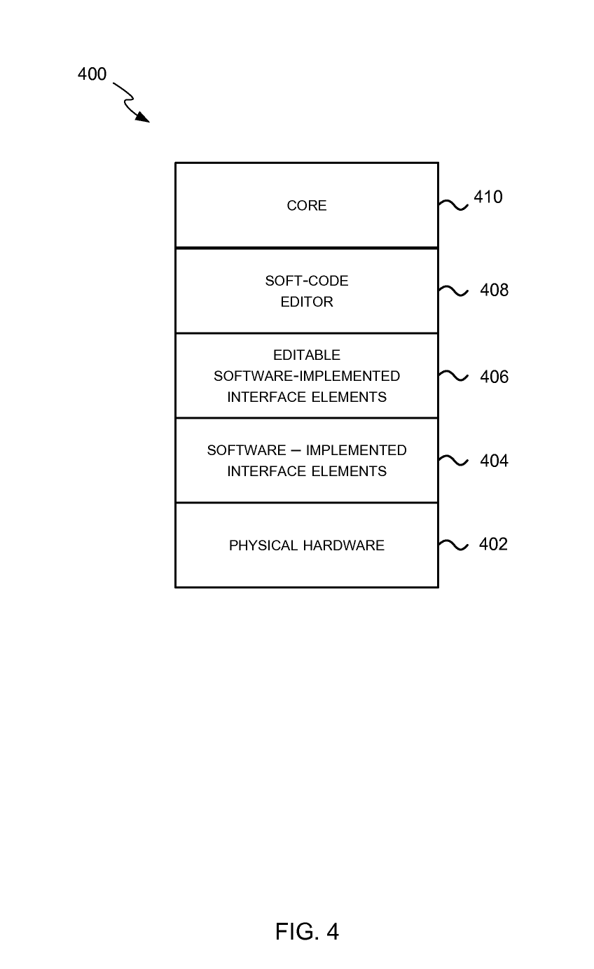

FIG. 4 is a schematic diagram showing a multi-layered architecture for a customizable appliance. The diagram shows a plurality of layers on an appliance 400 which can be exposed to a user of a client device via a network interface. The appliance has physical hardware layers 402 some of which are the functional and physical interface layers 301, 310 described with reference to FIG. 3 (e.g. which drive the operation of the device or provide physical interface elements). These elements are always present on the appliance; however, their functions may be changed by alterations made by the user to the program files.

The appliance can also have a plurality of software implemented interface elements 404 to enable the alteration of program files at the appliance using a remote user interface. In various embodiments the software implemented interface elements 404 may be Hyper Text Markup Language version 5 (HTML5) and/or Asynchronous Java and XML (AJAX) applications. In another example the software implemented interface elements may be Application Programming Interfaces (APIs) associated with program files running on the appliance and which may be used to interface the remote user interface elements to the program files executing various functions of the appliance. In various embodiments the APIs conform to Representational State Transfer (REST) constraints (the interfaces are RESTful).

The software implemented interface elements 404 may be arranged to provide the remote user interface to the client device in the form of a web based graphical user interface (as described above). Various device controls may also be operated using the graphical user interface. For example an alarm clock may have physical controls for snooze and on/off, but a webpage can be used for editing alarm times, setting recurrences, altering the alarm type and other functions.

One or more of the software implemented interface elements may be editable software interface elements 406, for example, software implemented interface elements may be comprised of wiki pages, or other editable webpages. In an embodiment the editable webpages can be HTML5 and/or AJAX-based webpages. In various embodiments the software implemented interface elements may be arranged to run on the client device if, for example, the client device is more powerful than the appliance. In an example, a user accessing the appliance via a user interface may be able to customize the web-based interface by adding different controls, changing the function of the controls or changing the layout of the interface

The software implemented interface elements may comprise a soft-code editor 408. The term “soft-code” is used to refer to program files which are editable. The ability to edit program files enables the user to change the functionality of the device by adding new features to the device, for example by adding calendar synchronization to an alarm clock or networking multiple alarm clocks so that their snooze features are linked. In an example a first set of program files stored at the appliance are soft-code files. The “soft-code” may be written using a web-API. The soft-code may be written in a scripting language, for example Javascript.

The soft-code files may also be written in a programming language (for example C++, C# or other appropriate language), using a development environment. An example of an appropriate development environment is Microsoft® Visual Studio®. In various embodiments the soft-code may be a wrapper for the hardware, for example a motor module may be wrapped as an “alarm hammer” that can be “rung” at a definable frequency. Control logic, for example logic which controls when to ring the alarm may also be written as editable program files (i.e. soft-code).

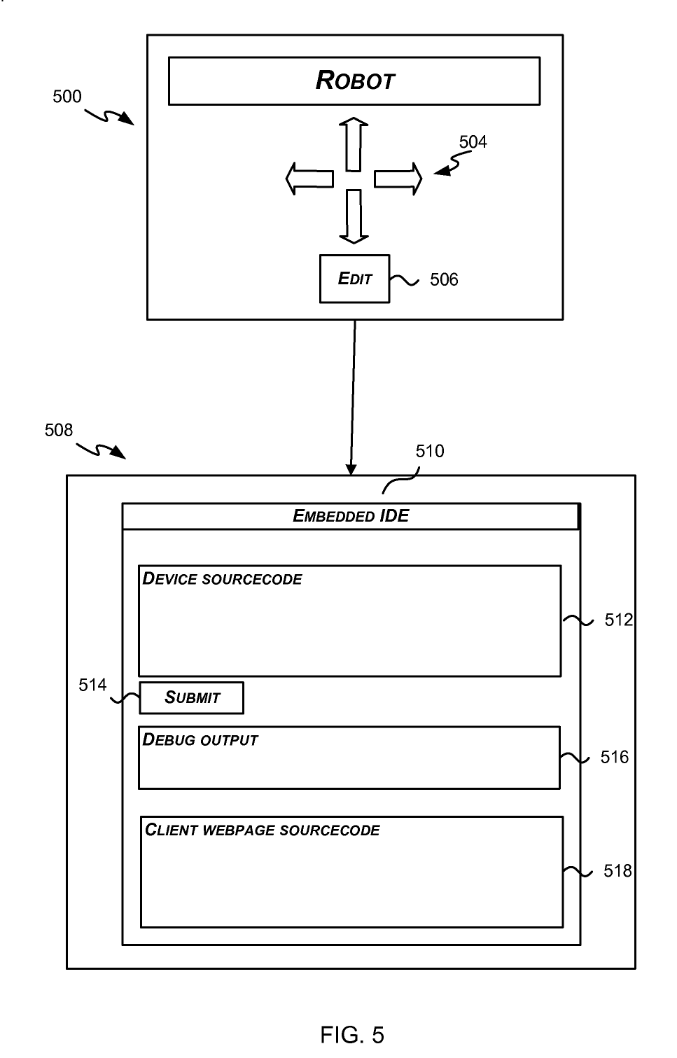

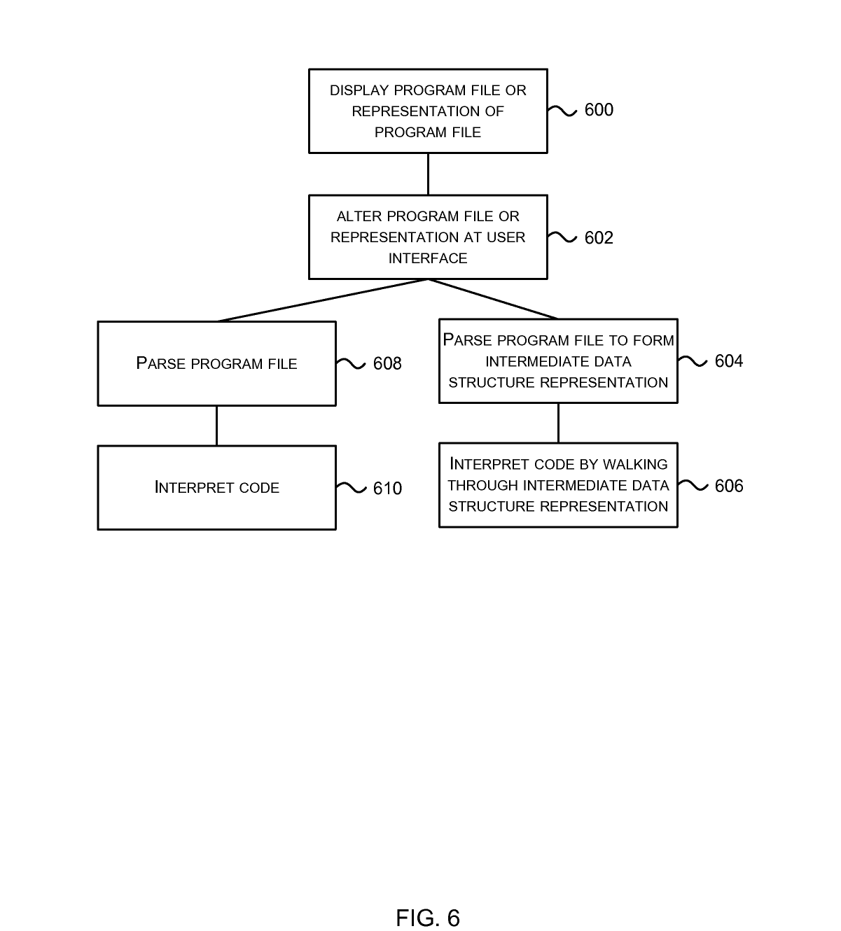

The appliance can also have a core layer 410 comprising an executive to support the appliance. The core layer 410 may comprise various non-editable or “hard-code” program files. In an example the core layer 410 may comprise control logic to support various aspects of the web-server, the AJAX webpages which permit soft-code editing and reflection on the program code classes to create a RESTful API, wherein reflection comprises dynamically modifying the execution of the program files at run-time and is described in more detail below with reference to FIG. 5 and FIG. 6.

In various embodiments certain aspects of the core layer or other layers may be secured to prevent the program files being altered at these layers by unauthorized users. The secured program files may be files which have been secured by a user of the appliance in order to prevent alteration or program files which have been secured by the manufacturer. In an example the manufacturer may secure certain program files which are critical to the operation of the appliance to prevent the files being altered. In some embodiments different users may have different levels of access to the program files, for example, an advanced user or administrator may have more access than a novice user. In many examples, the core layer 410 cannot be edited by a user and to implement a change to the functionality of the core layer a user may be able to request that updates are downloaded to the appliance by the manufacturer or other third party. In other examples the device may automatically contact the manufacturer at specified intervals to check if updates to core functionality are available.

FIG. 5 is a schematic diagram of an example user interface 500 at a client device. The user interface may enable a user of a client device to control an appliance and also to explore the functionality of the appliance. A first page of the user interface 500, which may be a webpage which is displayed automatically on connecting a client device to the appliance, may comprise a control interface. In an example (shown in FIG. 5) the user interface is a user interface for controlling a robot, e.g. a robot arm for use in a manufacturing environment, and the control interface is implemented as one or more arrows 504 which may allow the user to control the direction of operation of the robot arm by clicking on a particular arrow, e.g. forwards, backwards, left, right. Additional control functions may be implemented at the user interface by the user, or by the manufacturer of the device.

In an example the user interface may also comprise an edit function 506 which may be implemented as a control, such as a soft button, which when clicked on by the user navigates to a second or further webpage 508. In an example the second or further webpage comprise an embedded integrated development environment (IDE) 510 which allows the user to directly access the embedded source code of the device. The embedded source code may be editable soft-code. The embedded integrated development environment may comprise one or more text boxes in which the source code may be displayed and edited.

A first text box 512 may be used to edit the device source code. A user may make edits to the source code and submit the changes by clicking on a submit control 514. The source code may comprise various editable fields, properties and events. For example a user may want define and connect an event (action to be executed) to a method (how the action is to be executed) and a defined property (what is to be used to execute the action).

In a first example the text boxes may be simple text boxes, however, syntax highlighting and/or syntax checking may additionally be used. Auto-completion may also be used. In an example, if the user types “uparrowbox.” (ending with a dot), the client may query the appliance as to what valid completions there are, e.g. which methods or properties the uparrowbox has and then display them to the user. In various examples the appliance may send a full API to the client device when the edit page loads, so that auto-complete does not require a full round trip to appliance every time it is used.

The embedded IDE may also comprise one or more boxes to provide debug information 516 or other information about the validity of the source code or any errors to the user. The embedded IDE may also display a text box 518 in which the user can edit source code for one or more editable webpages of the device, for example to change one or more functions of the remote user interface or to add or remove functions to the remote user interface. The user is therefore able to edit both sides of the API by editing both the device source code (e.g. in box 516) and the webpage source code (e.g. in box 518).

The appliance may be provided with some change/version control systems e.g. when a user “checks in” or saves a set of changes they may be stored as a “change-set” that could be reverted later if the changes prove to be bad. In an example, as described above, a program file may initially be executed as a temporary file and stored later as a permanent file. Storing the changes as separate files allows the history of changes to be tracked. In various examples the user may need to have permission to edit the user interface or various levels of permissions may be implemented to enable various levels of access to the device.

In another example the user interface may include a plurality of tabs or menu options such as: a fields and properties tab (in which a user can define various fields which can be edited and which may also include fields which have been pre-defined by the manufacturer or previously specified by the user), a methods tab (which may allow a user to define methods which perform a function through a predefined field or property) and an events tab. For example a user may want to cause an alarm to ring, and may define an “alarm button” field and then to trigger the alarm the user may define an “alarm ring” method which acts on the alarm button field to trigger the alarm. The events tab may be used to specify when a user wants the alarm to be triggered by connecting up an event (action to be executed) to a method (how the action is to be executed) and a defined property (what is to be used to execute the action).

In an embodiment, the code is RESTful. For example, the fields and properties may be considered to be resources which are identified by a unique resource identifier (URI). The resources themselves may be considered to be conceptually separate from the representations that are returned to the client. In an example, the server does not send its entire database of program files to the client, but rather, some HTML or XML or other script that represents some database records. The exact format of the representation sent to the client device may depend on the details of the request and the server implementation.

The representation of the resource held by the client device provides enough information about the resource (for example any metadata associated with the resource) that altering the resource enables the program files to be altered on the server, for example using the methods and events defined at the user interface 500.

In an example internal class APIs can be exposed using a RESTful API by using reflection (e.g. observing and modifying the code executing at run time) on one or more of the internal classes of the code stored in one or more of the program files to create a Document Object Model (DOM). The DOM is a representation of the code stored in program files at the appliance. The DOM is a platform- and language-neutral interface that allows programs and scripts to dynamically access and update the content, structure and style of the program code. The DOM can be further processed and the results of that processing can be incorporated back into the program files. Therefore by editing the DOM the user can alter the functionality of the appliance. In various embodiments automatic parsing of the DOM may be carried out to improve the reflection process by including more information that is not normally available in the DOM. For example, more information on method parameters may be included.

FIG. 6 is a flow diagram of an example method of carrying out interpretation on program files. A program file or a representation of the program file is displayed at the user interface (block 600). The representation may be a DOM representation. The user alters the program file or representation at the user interface (block 602) to make changes to the functionality of the program file which can be executed at the appliance. In some examples the user may alter the representation using a text editor and by entering text directly into the displayed program file. In other examples the user may alter the program file by using graphical representation. For example the program file may be represented as a flow chart and the user may be able to make changes by adding, removing or restructuring elements in the flow chart.

In some examples, the altered program files may be compiled on the appliance. In other examples, however, the changes in the program file may be executed at the appliance using interpretation. In contrast to compiling the complete program file into an executable prior to run-time, a parser parses the program file when it is received by the appliance. Paring the program file may enable the interpreter to form an intermediate data structure representation (block 604), for example a “syntax tree” representation. Each node in the syntax tree represents a construct occurring in the code. In an example if the node is a “while” node, then it has two leaves, a condition and an action—and it causes the action to be executed repetitively until the condition becomes false.

The parsed intermediate data structure representation may be serialized before being saved at the appliance data store. Serializing the intermediate data structure representation speeds up subsequent loading of the representation when compared to parsing each time as parsing is a relatively slow process. At run-time, the code is interpreted (in block 606), by walking through the intermediate data structure for example, walking through the syntax tree and executing the appropriate action at each node. In some examples, for example where the program file is written in Javascript, an intermediate data structure may not be formed by the parser prior to run-time. The raw text of the program file may be first parsed (block 608) and then interpreted (block 610) “on-the-fly” at run-time.

In an example where multiple program files are stored at the appliance, if one file, or only a few files are edited then the syntax trees for these files are regenerated and the syntax trees for the other files remain unchanged. Therefore this provides more flexibility to adapt code at the appliance because only those files that have been changed need to be re-interpreted. In a further example, the portion of a program file that has been changed may be determined and then only that portion may be re-parsed such that the syntax tree may be edited incrementally.

In a system where a user is unable to alter the program files in-situ at the appliance, to change the function of an appliance or apply a software update by altering the program files, the user may copy the program file to the client device in order to edit the program file. Copying the program file would comprise either downloading the program file from the appliance or obtaining it by other appropriate means, for example, from a manufacturer web-site or a third party web-store. The user would also have to have appropriate development tools installed at the client device, for example an editor or development environment. The program file may then be compiled at the client device or on the appliance into an executable file and depending on where the compilation is performed either a copy of the executable file (where compilation is performed on the client device) or the edited program file (where compilation is performed on the appliance) is transferred to the appliance before execution in order to alter the function of the appliance.

In contrast, in many of the examples described herein the client device has no special tools or applications installed and can act as a thin client for the appliance. Each time changes are made to the representation of the program file at the client device the changes are implemented at the appliance via the APIs and executed using interpretation at the appliance without the need to recompile the program file or transfer an executable file between the client and the appliance. Although the use of interpretation may result in a slight increase in system overheads at run-time it reduces the required network bandwidth as the program files are not compiled at the client device before being transferred to the appliance. The use of interpretation also allows changes to the program files to be made and tested without requiring a compiler to turn the code into an executable format.

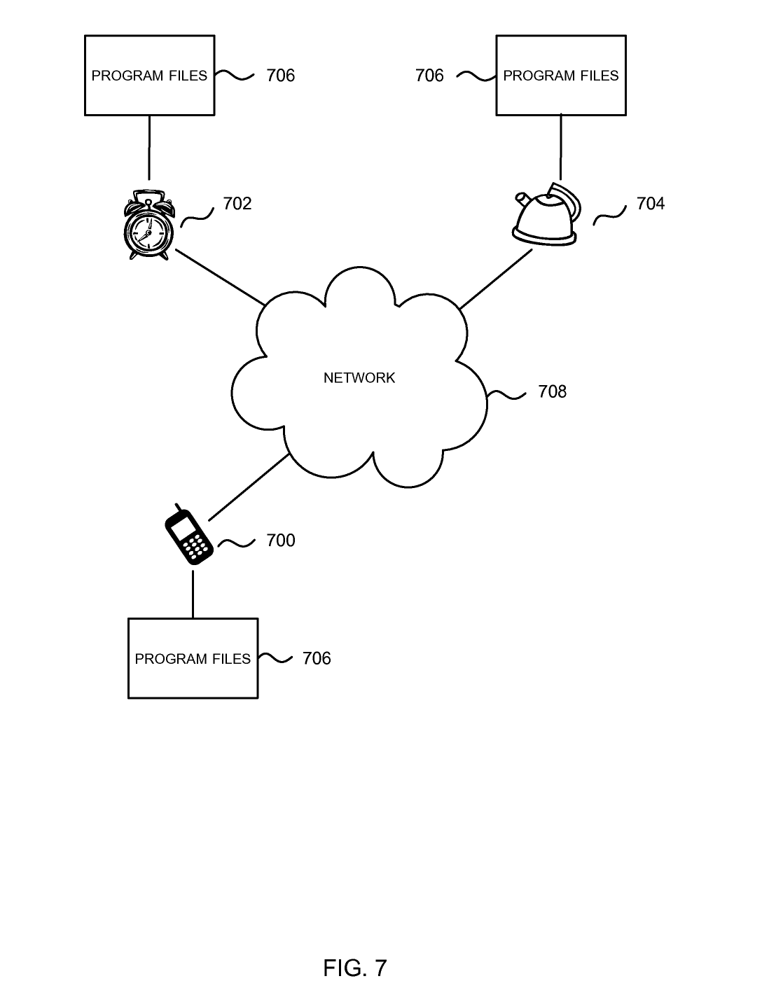

FIG. 7 is a schematic diagram of sharing and executing program files over multiple appliances. In an embodiment an appliance 700 may support one or more soft-code program files which execute functions that may also be run on compatible appliances 702, 704 where the program code of the compatible appliance supports the functionality required by the program file. For example a user running a program file 706 which informs the user of the outdoor temperature on their mobile device (which may be a smart-phone) may also wish to have the functionality of that program file on their alarm clock. Therefore the user could share the program file over a network 708 and execute the program file on multiple appliances.

Soft-code program files which can be executed across one or more devices may be in the form of applications (“apps”). Applications may be comprised of a single soft-code program files or multiple soft-code program files which can be executed on one or more devices. In some embodiments the user may be able to purchase the “app” program files from an online store. For example, for a novice user accessing and editing the program files of an appliance may to too challenging, however, the user may be able to specify that the appliance executes one or more applications which are stored at a data store on the appliance, stored on another appliance or the client device or which can be obtained from a remote device, for example an online store.

Furthermore running applications across multiple devices may increase their contextual use and relevance. In an example a user could execute an application which implements parts of its functionality on multiple devices, for example a “my morning routine” application which implements parts of its functionality on the user's alarm clock, part of its functionality on the user's shower and part of its functionality on the user's alarm clock. Running applications across multiple devices may also increase the fault tolerance of the application, for example an application may be more tolerant to disconnection or failure of a single appliance.

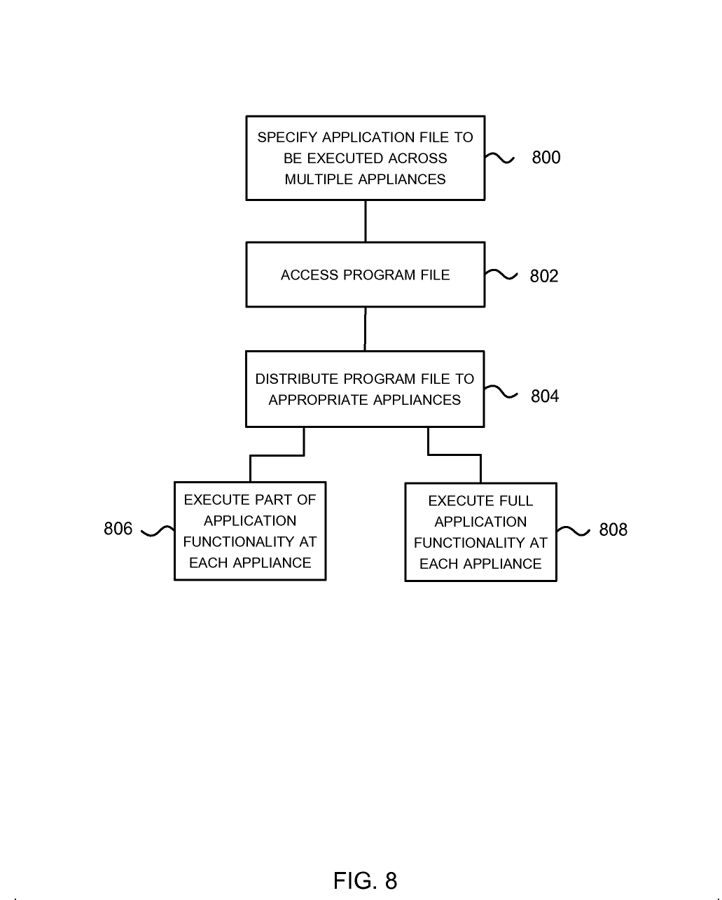

FIG. 8 is a flow chart of an example method of running an application over multiple devices. In an example an appliance can be arranged to share one or more program files with one or more further appliances via the appliance network interfaces. A user of a client device specifies that an application is to be executed across multiple appliances (block 800). For example the user may specify that all of the functionality of the application is to be executed across multiple appliances, or that parts of the functionality of the application are to be executed on a first device and parts of the functionality are to be executed on a second or further appliance, such that the functions executed on the separate appliances comprise a single application. The program files are accessed (block 802) and distributed across the appropriate appliances (block 804). For example a user may specify at a user interface of an appliance that the appliance is to share functionality with a second appliance. The first appliance can then distribute the appropriate soft-code program files to the second appliance. The devices may be arranged to each execute part of the functionality of the program files (block 806) or to separately execute the full functionality of the program files (block 808).

In an embodiment a “device manager” application running on one or more clients (e.g. a home PC) may track what appliances the user owns and what their specifications and capabilities are, and assist the user with suggesting applications which are compatible with and take advantage of the particular appliances. The device manger may further be enabled to perform the distribution of code amongst devices.

In another embodiment, the allocation of program files 802 to applications may be done using an automatic algorithm which might use factors such as the relative computing power of devices, their likelihood of being “off” or in standby mode, and how much of the application functionality relies on that appliance. This may reduce user-perceived application latency since code is running “close to” the I/O hardware it is interacting with. In an example sending code to multiple devices may create redundancy so that if one is off, in standby mode, broken, or removed, an application could nonetheless run if the code was redundantly available elsewhere.

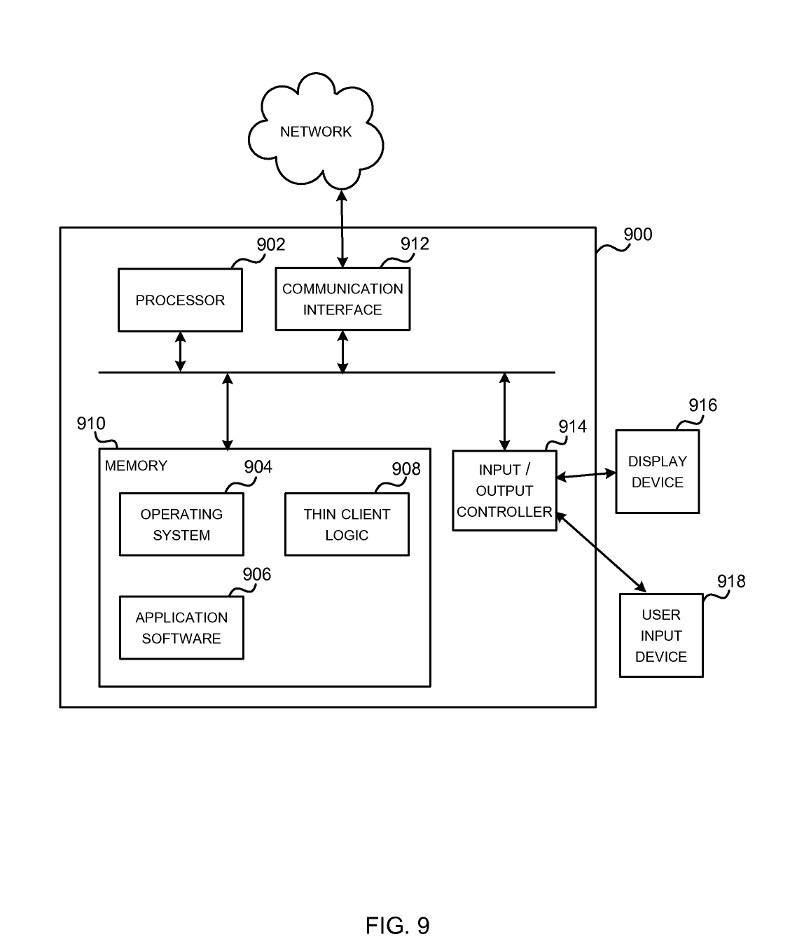

FIG. 9 illustrates various components of an exemplary computing-based device 900 which may be implemented as any form of a computing and/or electronic device, and in which embodiments of a client device for configuring appliances may be implemented.

Computing-based device 900 comprises one or more processors 902 which may be microprocessors, controllers or any other suitable type of processors for processing computer executable instructions to control the operation of the device in order to provide a remote user interface for an appliance. In some examples, for example where a system on a chip architecture is used, the processors 902 may include one or more fixed function blocks (also referred to as accelerators) which implement a part of the method of configuring appliances in hardware (rather than software or firmware). Platform software comprising an operating system 904 or any other suitable platform software may be provided at the computing-based device to enable application software 906 to be executed on the device. In some embodiments the application software may include thin client logic 908 or other application logic arranged to enable the user to connect to an appliance. In an example the thin-client logic may be a web-browser.

The computer executable instructions may be provided using any computer-readable media that is accessible by computing based device 900. Computer-readable media may include, for example, computer storage media such as memory 910 and communications media. Computer storage media, such as memory 910, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 910) is shown within the computing-based device 900 it will be appreciated that the storage may be distributed or located remotely and accessed via a network or other communication link (e.g. using communication interface 912).

The computing-based device 900 also comprises an input/output controller 914 arranged to output display information to a display device 916 which may be separate from or integral to the computing-based device 900. The display information may provide a graphical user interface, such as a remote graphical user interface as described herein. The input/output controller 914 is also arranged to receive and process input from one or more devices, such as a user input device 918 (e.g. a mouse, keyboard, camera, microphone or other sensor). In some examples the user input device 918 may detect voice input, user gestures or other user actions and may provide a natural user interface. This user input may be used to control a remote user interface arranged to configure and appliance. In an embodiment the display device 916 may also act as the user input device 916 if it is a touch sensitive display device. The input/output controller 914 may also output data to devices other than the display device, e.g. a locally connected printing device (not shown in FIG. 9).

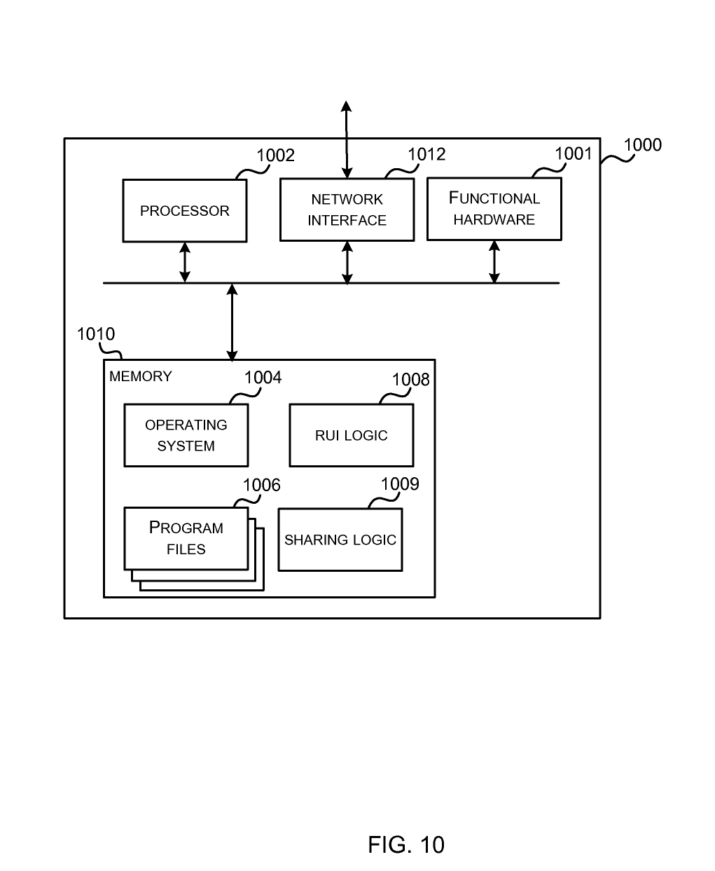

FIG. 10 illustrates various components of an exemplary appliance 1000 and in which embodiments of the methods for configuring appliances described herein may be implemented.

Appliance 1000 comprises functional hardware 1001 which is arranged to enable the appliance 1000 to perform its defined tasks or fulfill its purpose (e.g. where the appliance 1000 is a coffee maker, the functional hardware 1001 comprises the water boiler, piping, thermostats, etc required to make coffee). This functional hardware 1001 may comprise the physical user interface elements (e.g. buttons, screen, etc) which are provided integrated within the appliance. In addition, the appliance comprises one or more processors 1002 which may be microprocessors, controllers or any other suitable type of processors for processing computer executable instructions to control the operation of the appliance and to enable user customization of the appliance, as described above. In some examples, for example where a system on a chip architecture is used, the processors 1002 may include one or more fixed function blocks (also referred to as accelerators) which implement a part of the method of operation in hardware (rather than software or firmware). Platform software comprising an operating system 1004 or any other suitable platform software may be provided at the appliance to enable one or more program files 1006 and logic to generate the remote user interface 1008 to be executed on the device. In various examples, sharing logic 1009 is also provided which, when executed, enables the appliance to share program files with other appliances via a network interface 1012.

The computer executable instructions may be provided using any computer-readable media that is accessible by the appliance 1000. Computer-readable media may include, for example, computer storage media such as memory 1010 and communications media. As described above, computer storage media, such as memory 1010, includes volatile and non-volatile, removable and non-removable media implemented in any method or technology for storage of information such as computer readable instructions, data structures, program modules or other data and all the examples described with reference to FIG. 9 are also applicable in relation to the appliance shown in FIG. 10. Although the computer storage media (memory 1010) is shown within the appliance 1000 it will be appreciated that the storage may be distributed or located remotely and accessed via a network or other communication link (e.g. using network interface 1012).

As described above, the network interface 1012 is used to provide access to the program files 1006 stored in memory 1010 via a remote user interface generated by the RUT logic 1008 and displayed on a client device.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include computer storage devices comprising computer-readable media such as disks, thumb drives, memory etc and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method for customizing an appliance comprising, at a client device:
connecting to the appliance via a network interface;
accessing program files stored at the appliance via a remote user interface implemented at the appliance and displayed on the client device; and
receiving alterations to one or more of the program files stored at the appliance via the remote user interface;
wherein executing one or more altered program files at the appliance changes one or more aspects of the functionality of the appliance.

2. A method according to claim 1 wherein receiving alterations to one or more of the program files comprises editing the program file.

3. A method according to claim 1 wherein receiving alterations to one or more of the program files comprises replacing one or more of the program files.

4. A method according to claim 1 wherein receiving alterations to one or more of the program files comprises receiving alterations to a representation of one or more of the program files.

5. A method according to claim 4 wherein the representation is a Document Object Model representation created using reflection on one or more classes of the code stored in a program file.

6. A method according to claim 1 wherein at least one program file and/or at least a part of the remote user interface is stored at a remote device.

7. A method for customizing an appliance comprising, at the appliance:
storing one or more program files that when executed control the functionality of the appliance;
providing a remote user interface for display on a client device via a network interface, the remote user interface allowing a user to access and alter a stored program file;
receiving alterations to the program file via the remote user interface;
storing an altered version of the program file; and
executing the altered version of the program file, wherein executing the altered version of the program file changes one or more aspects of the functionality of the appliance.

8. A method according to claim 7 wherein the remote user interface comprises a development environment.

9. A method according to claim 7 wherein the remote user interface is an editable webpage.

10. A method according to claim 7 wherein executing the altered version of the program file comprises:
using a parser to compile the program code into an intermediate data structure; and
walking through the intermediate data structure and executing an appropriate action at each node.

11. A method according to claim 7, wherein the stored program files are logically divided into multiple layers and wherein the remote user interface allows a user to access stored program files in a subset of the layers.

12. A method according to claim 11 wherein a layer comprising one or more core program files is secured to prevent an unauthorized user from editing the program files.

13. An method according to claim 12 further comprising:
updating one or more core program files by downloading a file from a server associated with a third party via the network interface.

14. A method according to claim 7 wherein providing a remote user interface for display on a client device via a network interface comprises exposing one or more Application Programming Interfaces associated with stored program files.

15. A method according to claim 14 wherein the one or more Application Program Interfaces conform to Representational State Transfer constraints.

16. A method according to claim 7, further comprising:
sharing one or more program files with one or more other appliances via the network interface.

17. An appliance comprising:
a network interface;
a processor;
a data store arranged to store one or more program files and logic for generating a remote user interface;
wherein, when executed by the processor, the logic for generating a remote user interface causes the appliance to:
provide a remote user interface for display on a client device via the network interface, the remote user interface allowing a user to access and alter a stored program file;
receive alterations to the program file via the remote user interface;
store an altered version of the program file; and
execute the altered version of the program file, wherein executing the altered version of the program file changes one or more aspects of the functionality of the appliance.

18. An appliance according to claim 17 wherein the logic for generating a remote user interface comprises a web-server.

19. An appliance according to claim 17 wherein the data store is further arranged to store sharing logic, wherein, when executed by the processor, the sharing logic causes the appliance to share one or more program files with one or more further appliances via the network interface.

20. An appliance according to claim 19 wherein sharing one or more of the program files with one or more further appliances comprises executing a part of the functionality on the appliance and causing a further part of the functionality to be executed on a second or further appliance.
